(19) United States
(12) Patent Application Publication
(10) Pub. No.: US 2017/0242728 A1
(43) Pub. Date: Aug. 24, 2017

(54) PARALLEL PROCESSING APPARATUS, POWER COEFFICIENT CALCULATION PROGRAM, AND POWER COEFFICIENT CALCULATION METHOD

(71) Applicant: FUJITSU LIMITED, Kawasaki-shi (JP)

(72) Inventor: Jun MOROO, Isehara (JP)

(73) Assignee: FUJITSU LIMITED, Kawasaki-shi (JP)

(21) Appl. No.: 15/386,792

(22) Filed: Dec. 21, 2016

(30) Foreign Application Priority Data
Feb. 24, 2016 (JP) 2016-032582

(51) Int. Cl. G06F 9/48; G06F 1/28

(52) U.S. Cl. CPC G06F 9/4893; G06F 1/28

(57) ABSTRACT

A power coefficient calculation method in a parallel computing system is disclosed. When executing a job in parallel by using a plurality of calculation nodes, calculating and updating a power coefficient of each of the plurality of calculation nodes, the power coefficient being used to calculate a power consumption of the calculation node in accordance with execution of the job, based on a power consumption measured during an execution of a first job having a difference in power consumptions of the calculation nodes smaller than a given value among a plurality of jobs to be executed.

### CROSS-REFERENCE TO RELATED APPLICATION

This application is based upon and claims the benefit of priority of the prior Japanese Patent Application No. 2016-032582, filed on Feb. 24, 2016, the entire contents of which are incorporated herein by reference.

### FIELD

The embodiments discussed herein are related to a parallel processing apparatus, a power coefficient calculation program, and a power coefficient calculation method.

### BACKGROUND

A computing system that executes processing by using a plurality of compute nodes in parallel is widely in use. The computing system, in which a plurality of compute nodes operate concurrently, consumes a relatively large amount of power. Therefore, for example, when execution of a plurality of jobs is scheduled, in some cases, the power consumed by each compute node is predicted and is controlled so that the entire power consumption does not become excessively large.

Here, a method of predicting the power consumption of a certain device is considered. For example, it has been proposed that a power estimating apparatus acquires a plurality of power values for each combination of parameters from a power estimation target apparatus, creates a power prediction formula based on the magnitude of variation in power values relative to the mean of the power values, and estimates the power consumption of the power estimation target apparatus by using the power prediction formula. It has also been proposed, for example, that, with reference to a power consumption table representing power consumption obtained in association with an event of each logical gate, a power consumption prediction apparatus predicts the power consumption of each logical gate from the event.

In addition, a method has been proposed in which, in a logical cell library generation system, assuming that data that is input to memory is random, a vector that takes into account the operating mode of the memory is created, and power consumption is calculated for each cycle specified by the vector.

Examples of the related art techniques include Japanese Laid-open Patent Publication No. 2015-111326, Japanese Laid-open Patent Publication No. 2001-265847, and Japanese Laid-open Patent Publication No. 10-222545.

When the power consumption of a computing system is predicted, it is conceivable to take into consideration individual characteristics for power consumption of each compute node. For example, even when a plurality of compute nodes execute the same processing, the compute nodes may have different power consumptions, which result from variation in the quality of parts included in the compute nodes that is caused in the manufacturing processes of the parts. When such characteristics of individual compute nodes are acquired in advance as power coefficients, the power coefficients may be used to aid in prediction of power consumption.

For example, a method is conceivable in which, in order to measure power coefficients, power consumption of each compute node is measured by causing the compute node to execute a test program that imposes a uniform load on all of the compute nodes. However, this method has problems in that the usual operation of compute nodes has to be interrupted because of execution of the test program, and in that additional power is consumed for execution of the test program.

In one aspect, an object of the present disclosure is to provide a parallel processing apparatus, a power coefficient calculation program, and a power coefficient calculation method with which power coefficients may be obtained without execution of a special program for testing.

### SUMMARY

According to an aspect of the invention, a power coefficient calculation method in a parallel computing system is disclosed. When executing a job in parallel by using a plurality of calculation nodes, calculating and updating a power coefficient of each of the plurality of calculation nodes, the power coefficient being used to calculate a power consumption of the calculation node in accordance with execution of the job, based on a power consumption measured during an execution of a first job having a difference in power consumptions of the calculation nodes smaller than a given value among a plurality of jobs to be executed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a parallel processing apparatus according to a first embodiment;

FIG. 2 is a diagram illustrating a computing system according to a second embodiment;

FIG. 3 is a diagram illustrating an example of hardware of a management node of the second embodiment;

FIG. 4 is a diagram illustrating an example of hardware of a compute node of the second embodiment;

FIG. 5 is a diagram illustrating an example of hardware of a data storage server of the second embodiment;

FIG. 6 is a diagram illustrating an example of functionality of the management node of the second embodiment;

FIG. 7 is a diagram illustrating an example of a power coefficient table of the second embodiment;

FIG. 8 is a flowchart illustrating an example of determination of a power coefficient of the second embodiment;

FIG. 9 is a flowchart illustrating an example of determination of a power coefficient of a third embodiment;

FIG. 10A and FIG. 10B are diagrams illustrating an example of the total numbers of instructions and an example of predicted power consumptions of the third embodiment; and

FIG. 11A and FIG. 11B illustrate an example of measured power consumptions and an example of power coefficients of the third embodiment.

### DESCRIPTION OF EMBODIMENTS

Hereinafter, the present embodiments will be described with reference to the accompanying drawings.

### First Embodiment

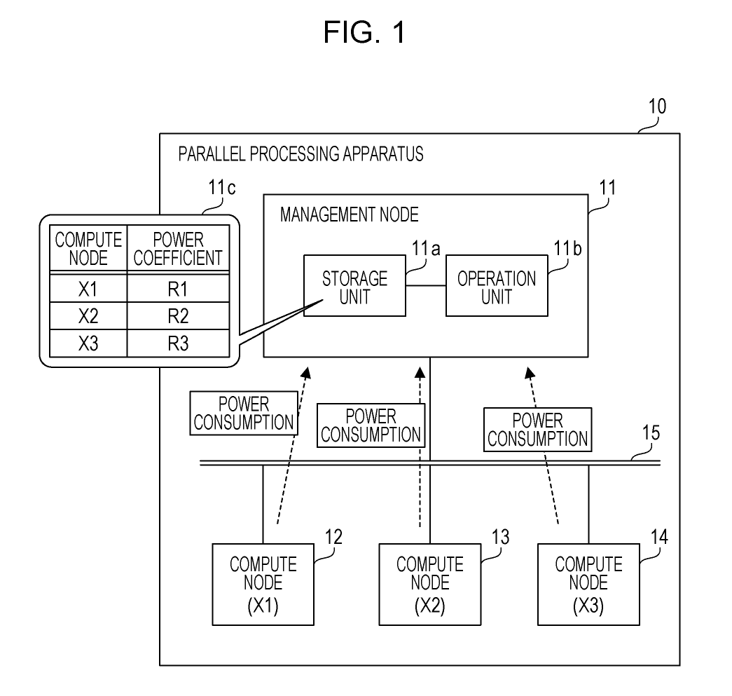

FIG. 1 is a diagram illustrating a parallel processing apparatus of a first embodiment. A parallel processing apparatus 10 includes a management node 11 and compute nodes 12, 13, and 14. The management node 11 and the compute nodes 12, 13, and 14 are coupled to a network 15. The management node 11 is a node that manages jobs to be executed by the compute nodes 12, 13, and 14. The compute nodes 12, 13, and 14 are nodes for arithmetic processing that execute a job in parallel.

Here, one job includes a plurality of instructions. The management node 11 assigns execution of a plurality of instructions to the compute nodes 12, 13, and 14 so as to distribute the execution across these compute nodes, and thus may execute one job in parallel by using the compute nodes 12, 13, and 14. In addition, the parallel processing apparatus 10 identifies the compute nodes 12, 13, and 14 by their respective compute node identifiers (IDs). The compute node IDs are respective pieces of identification information of a plurality of compute nodes. For example, the compute node ID of the compute node 12 is “X1”. The compute node ID of the compute node 13 is “X2”. The compute node ID of the compute node 14 is “X3”.

The management node 11 includes a storage unit 11a and an operation unit 11b. The storage unit 11a may be a volatile storage device, such as random access memory, or may be a nonvolatile storage device, such as flash memory. The operation unit 11b is, for example, a processor. The processor may be a central processing unit (CPU) or a digital signal processor (DSP), and may include an integrated circuit, such as an application specific integrated circuit (ASIC) or a field programmable gate array (FPGA). The processor, for example, executes a program stored in RAM. In addition, “processor” may be a set of two or more processors (a multiprocessor). The management node 11 may be called a “computer”. In addition, the compute node 12, 13, or 14, like the management node 11, includes a processor and RAM.

The storage unit 11a stores respective power coefficients for the compute nodes 12, 13, and 14. The power coefficients are information used for calculation of the respective values of power consumption of the compute nodes 12, 13, and 14 when the compute nodes 12, 13, and 14 execute a job in parallel. For example, the storage unit 11a stores power coefficient information 11c indicating the correspondence between the compute node and the power coefficient. Here, the relationship between the power coefficient and the power consumption is expressed, for example, by the following formula (1).

p=c×r (1)

where p is power consumption (in watts (W)), and c is the total number of instructions that are executed by a compute node in association with execution of a job. For example, c may be acquired by using a performance counter. In addition, r is a power coefficient (in watts per instruction). The power coefficient may be considered to be an amount representing the characteristics of power consumption of each compute node. For example, when the compute nodes 12, 13, and 14 have approximately the same total number of instructions and differ in power consumption, the differences are considered to result from the respective characteristics of the compute nodes. Such differences in power coefficient may also, for example, result from variation in the quality of parts (for example, RAM, a processor, and the like) included in each compute node.

The operation unit 11b, when executing a job in the parallel processing apparatus 10, detects a job having a difference in the power consumption of each compute node smaller than a given value (a first job) among a plurality of jobs to be executed. For example, after executing a certain job in parallel by using the compute nodes 12, 13, and 14, the operation unit 11b collects power consumptions associated with execution of the job from the compute nodes 12, 13, and 14. Further, the operation unit 11b determines whether or not the difference in power consumption of each of the compute nodes 12, 13, and 14 is smaller than the given value. If the difference in power consumption is smaller than the given value, an approximately uniform load of the job in question may be considered to be imposed on all of the computing loads 12, 13, and 14. In this case, the total numbers of instructions executed by the compute nodes 12, 13, and 14 in accordance with assignment of the job in question are highly likely to be approximately the same. When the total numbers are highly likely to be approximately the same, it is possible to derive characteristics for the power consumption of a compute node based on formula (1) by using a power consumption actually measured at that time and the total number of instructions executed by each of the compute nodes 12, 13, and 14. Note that, if the difference in power consumption is large, there is a possibility that the total numbers of instructions of all of the compute nodes are substantially different to each other, or that even when the total numbers of instructions are approximately the same, the processing details differ among the compute nodes. In such a case, calculation of power coefficients is to be avoided.

In order to determine whether or not the difference in power consumption of each of the compute nodes 12, 13, and 14 in association with execution of a job is smaller than the given value, the operation unit 11b may determine whether or not the difference between the largest value and the smallest value of the power consumptions acquired from the compute nodes 12, 13, and 14 is smaller than the given value. This is because the difference between the largest and smallest values of the power consumptions gives the largest power consumption difference in each compute node. Making a determination using a difference between the largest and smallest values of the power consumptions enables variation in power consumption of each of the compute nodes 12, 13, and 14 to be evaluated simply.

The operation unit 11b updates the power coefficient of each compute node based on the power consumption during execution of the detected job. For example, the operation unit 11b calculates a power coefficient R1 of the compute node 12 from the power consumption during execution of the detected job and the total number of instructions by using formula (1). The operation unit 11b calculates a power coefficient R2 of the compute node 13 from the power consumption during execution of the detected job and the total number of instructions by using formula (1). The operation unit 11b calculates a power coefficient R3 of the compute node 14 from the power consumption during execution of the detected job and the total number of instructions by using formula (1). Note that the operation unit 11b may acquire the total number of instructions executed for the job in question from each of the compute nodes 12, 13, and 14.

For example, the operation unit 11b registers power coefficients obtained respectively for the compute nodes 12, 13, and 14 in the power coefficient information 11c. When a power coefficient calculated previously for each compute node is registered in the power coefficient information 11c, it is conceivable that the operation unit 11b updates the power coefficients of the compute nodes 12, 13, and 14 based on the power coefficients calculated previously and power coefficients calculated currently.

In more particular, when some compute node fails, the failed compute node is sometimes replaced with a new compute node. In this case, it is conceivable that a temporary power coefficient (for example, the mean of power coefficients of normal compute nodes) is set for the compute node after the replacement, so that operation is performed. At this point, the operation unit 11b selects, from among a plurality of jobs that are executed in usual operation, a job that is considered as imposing an approximately uniform load on all of the compute nodes by using the above method. Further, the operation unit 11b corrects the temporary power coefficient set for the compute node after the replacement, based on the measured power consumption of each compute node in association with execution of the selected job. One example of the correction method could be that the mean of the power coefficient calculated previously and the power coefficient in accordance with the actual result of the current job execution is employed as the current power coefficient. In such a way, with the parallel processing apparatus 10, it is possible to improve the power coefficient for the compute node after replacement while continuing usual execution of a job.

Here, for example, in order to obtain power coefficients for the compute nodes 12, 13, and 14, a method is conceivable in which each compute node is caused to execute a test program that imposes a uniform load on all of the compute nodes, so that the power consumption of each compute node is measured. However, this method has problems in that, the usual operation of the compute node 12, 13, or 14 has to be interrupted in order to execute the test program, and that extra power is consumed by the compute node 12, 13, or 14 in order to execute the test program. That is, in order to acquire a power coefficient, executing a special program for testing, itself, is inefficient for operation of the computing system.

In contrast, with the parallel processing apparatus 10, it is possible to obtain power coefficients for the compute nodes 12, 13, and 14 while continuing usual execution of a job as described above. Therefore, time may not be used to execute a special program, such as a test program, and usual operation performed by the compute node 12, 13, or 14 may not be interrupted. In addition, avoiding executing a test program results in avoiding consuming extra power for the compute node 12, 13, or 14 to obtain a power coefficient.

In such a way, with the parallel processing apparatus 10, it is possible to efficiently obtain power coefficients of compute nodes through usual operation. For example, prior to executing a certain job, the parallel processing apparatus 10 obtains predicted power consumptions of compute nodes by using formula (1) with the power coefficients R1, R2, and R3 of the compute nodes registered in the power coefficient information 11c. Further, the parallel processing apparatus 10 is able to predict the power consumption of the entirety of compute nodes from the sum of the predicted power consumptions of compute nodes. Thus, the parallel processing apparatus 10 may suitably schedules execution of the job in accordance with the predicted power consumptions.

### Second Embodiment

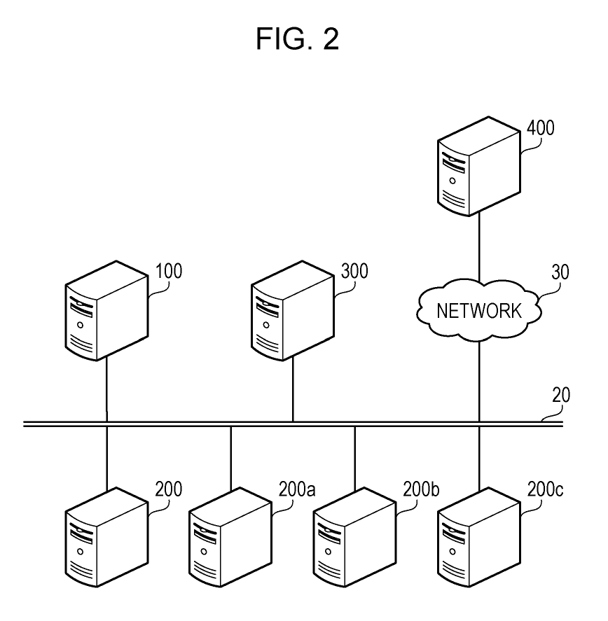

FIG. 2 is a diagram illustrating a computing system of a second embodiment. The computing system illustrated in FIG. 2 includes a management node 100, compute nodes 200, 200a, 200b, and 200c, a login node 300, and a data storage server 400.

The management node 100, the compute nodes 200, 200a, 200b, and 200c, and the login node 300 are coupled to a network 20. The data storage server 400 is coupled to a network 30. The network 30 is coupled to the network 20. For example, the network 20 is a network for management of the computing system. The form of an interconnect network of the compute nodes 200, 200a, 200b, and 200c, among these components, may be a direct network called, for example, mesh or torus. In addition, the network 30 may be a local network within a data center where the computing system is provided, or may be a wide-area network provided outside the data center.

The management node 100 is a server computer that manages execution of a job assigned to the compute nodes 200, 200a, 200b, and 200c. The management node 100 receives job information from the login node 300. The job information includes information about the details of a job to be executed by the compute nodes 200, 200a, 200b, and 200c and the number of compute nodes to execute the job, and so on. The management node 100 submits a job to the compute nodes 200, 200a, 200b, and 200c and causes them to execute the job.

The compute nodes 200, 200a, 200b, and 200c are server computers that process a job submitted by the management node 100 in parallel. The number of compute nodes does not have to be four. The technology in which a large number of compute nodes are provided and a large-scale computing process is performed is called high-performance computing (HPC) in some cases.

The login node 300 is a server computer that is used for the user to log in to a computing system. For example, the login node 300 accepts a login of the user from a client server (not illustrated in FIG. 2) coupled to the network 30. The user may compile a program for a job by using the login node 300. The user may also input a job to be executed to the management node 100 through the login node 300. When the compute nodes 200, 200a, 200b, and 200c are to be used for execution of a job, the login node 300 sends job information to the management node 100.

The data storage server 400 is a server computer that stores various kinds of data. For example, the data storage server 400 is capable of delivering a program to be executed by the management node 100 to the management node 100.

Here, the management node 100 schedules jobs to be executed for the compute nodes 200, 200a, 200b, and 200c. During the scheduling, the management node 100 takes into account the power consumption of each compute node associated with execution of each job. The reason for this is to perform control so that the power consumption of the entire computing system does not become excessively large. The management node 100 uses the power coefficient of each compute node to predict a power consumption associated with execution of a job. For example, with such a power coefficient, the management node 100 may estimate the power consumption of each compute node associated with execution of a job by using formula (1).

However, in a computing system, there is a possibility that some compute node will fail. The failed compute node is replaced with a new compute node by, for example, an administrator of the computing system. This results in recalculating the power coefficient for the compute node after replacement. The management node 100 provides functionality that efficiently determines such a power coefficient for the compute node after replacement.

Next, hardware of each device included in the computing system will be described.

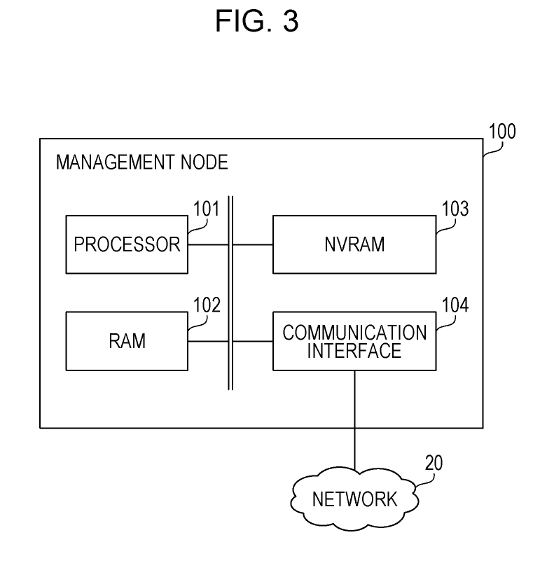

FIG. 3 is a diagram illustrating an example of hardware of a management node of the second embodiment. The management node 100 includes a processor 101, RAM 102, nonvolatile RAM 103, and a communication interface 104. Each unit is coupled to a bus of the management node 100.

The processor 101 controls the entire management node 100. The processor 101 may be a multiprocessor including a plurality of processing elements. The processor 101 is, for example, a CPU, a DSP, an ASIC, an FPGA, or the like. The processor 101 may be a combination of two or more elements of a CPU, a DSP, an ASIC, an FPGA, and the like.

The RAM 102 is the main storage device of the management node 100. The RAM 102 temporarily stores at least some of the programs of an operating system (OS) and application programs to be executed by the processor 101. In addition, the RAM 102 stores various kinds of data that are used for processing executed by the processor 101.

The NVRAM 103 is an auxiliary storage device of the management node 100. The NVRAM 103 stores programs of the OS, application programs, and various kinds of data. The management node 100 may include one of various auxiliary storage devices, such as flash memory and a solid state drive(SSD), as the NVRAM 103, or may include a plurality of auxiliary storage devices.

The communication interface 104 communicates with another device via the network 20.

Note that the login node 300 may be implemented by hardware similar to that of the management node 100.

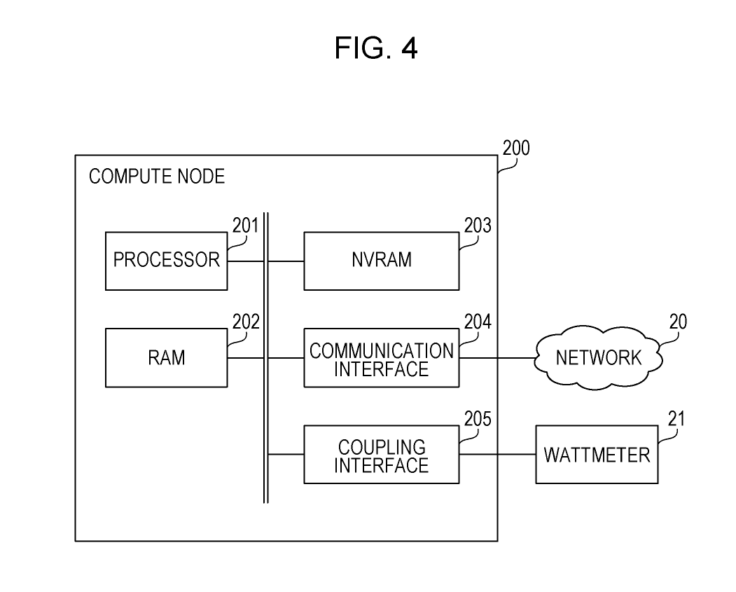

FIG. 4 is a diagram illustrating an example of hardware of a compute node of the second embodiment. The compute nodes 200, 200a, 200b, and 200c may be implemented by similar hardware. Therefore, only the hardware of the compute node 200 will be described here.

The compute node 200 includes a processor 201, RAM 202, NVRAM 203, a communication interface 204, and a coupling interface 205. Each unit is coupled to a bus of the compute node 200a.

The processor 201 controls the entire compute node 200a. The processor 201 may be a multiprocessor including a plurality of processing elements. The processor 201 is, for example, a CPU, a DSP, an ASIC, an FPGA, or the like. The processor 201 may be a combination of two or more elements of a CPU, a DSP, an ASIC, an FPGA, and the like.

The RAM 202 is the main storage device of the compute node 200. The RAM 202 temporarily stores at least some of the programs of an OS and application programs to be executed by the processor 201. In addition, the RAM 202 stores various kinds of data that are used for processing executed by the processor 201.

The NVRAM 203 is an auxiliary storage device of the compute node 200. The NVRAM 203 stores programs of the OS, application programs, and various kinds of data. The management node 100 may include one of various auxiliary storage devices, such as flash memory and an SSD, as the NVRAM 203, or may include a plurality of auxiliary storage devices.

The communication interface 204 communicates with another device via the network 20.

The coupling interface 205 acquires a power value measured by a wattmeter 21. The wattmeter 21 is a measuring instrument that measures power consumed by the compute node 200. Note that the wattmeter 21 may be integrated in the compute node 200.

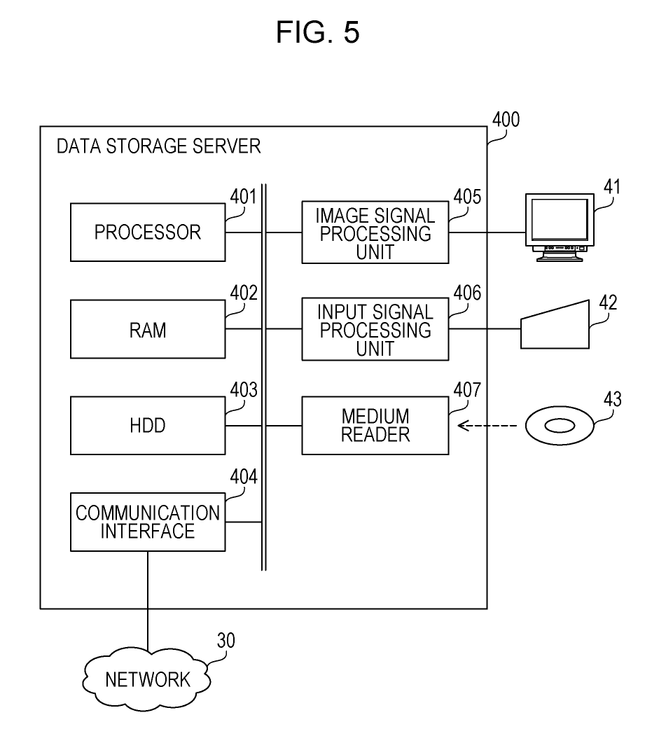

FIG. 5 is a diagram illustrating an example of hardware of a data storage server of the second embodiment. The data storage server 400 includes a processor 401, RAM 402, a hard disk drive (HDD) 403, a communication interface 404, an image signal processing unit 405, an input signal processing unit 406, and a medium reader 407. Each unit is coupled to a bus of the data storage server 400.

The processor 401 controls the entire data storage server 400. The processor 401 may be a multiprocessor including a plurality of processing elements. The processor 401 is, for example, a CPU, a DSP, an ASIC, an FPGA, or the like. In addition, the processor 401 may be a combination of two or more elements of a CPU, a DSP, an ASIC, an FPGA, and the like.

The RAM 402 is the main storage device of the data storage server 400. The RAM 402 temporarily stores at least some of the programs of an OS and application programs to be executed by the processor 401. In addition, the RAM 402 stores various kinds of data that are used for processing executed by the processor 401.

The HDD 403 is an auxiliary storage device of the data storage server 400. The HDD 403 magnetically writes and reads data to and from a magnetic disk included therein. Programs of the OS, application programs, and various kinds of data are stored in the HDD 403. The data storage server 400 may include an auxiliary storage device of another kind, such as flash memory or an SSD, or may include a plurality of auxiliary storage devices.

The communication interface 404 communicates with another device via the network 30.

The image signal processing unit 405 follows an instruction from the processor 401 to output an image to a display 41 coupled to the data storage server 400. As the display 41, one of various displays, such as a cathode ray tube (CRT) display, a liquid crystal display (LCD), and an organic electro-luminescent (EL) display, may be used.

The input signal processing unit 406 acquires an input signal from an input device 42 coupled to the data storage server 400 and outputs this signal to the processor 401. As the input device 42, one of various input devices, including pointing devices such as a mouse and a touch panel, a keyboard, and the like, may be used. A plurality of types of input devices may be coupled to the data storage server 400.

The medium reader 407 is a device that reads a program or data stored in the storage medium 43. As the storage medium 43, for example, a magnetic disk such as a flexible disk (FD) or an HDD, an optical disk such as a compact disc or a digital versatile disc, or a magneto-optical disk is used. In addition, as the storage medium 43, nonvolatile semiconductor memory such as a flash memory card may be used. The medium reader 407, for example, follows an instruction from the processor 401 to store a program and data read from the recording medium 43 in the RAM 402 or the HDD 403.

Next, the functionality of the management node 100 will be described.

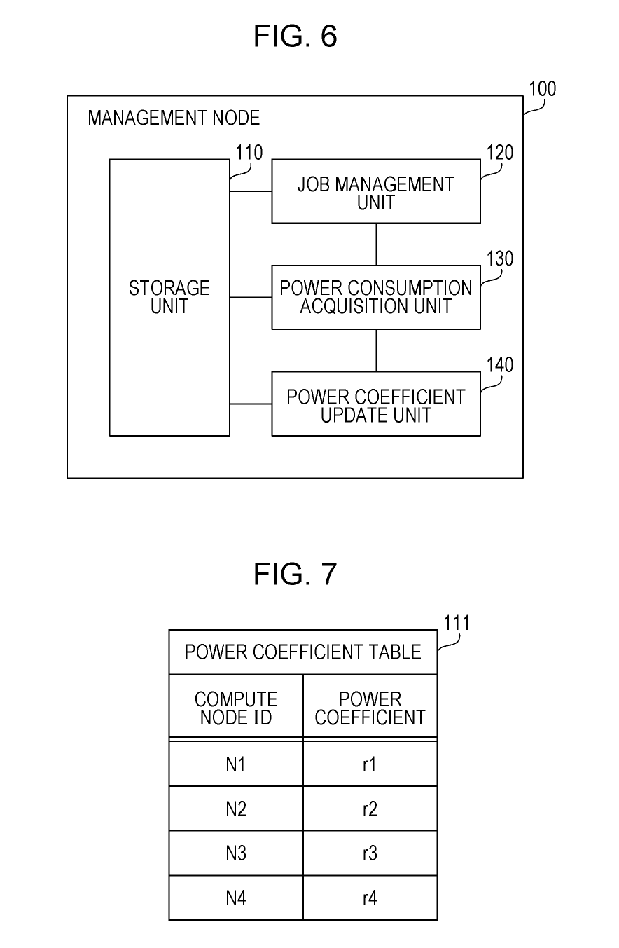

FIG. 6 is a diagram illustrating an example of functionality of the management node of the second embodiment. The management node 100 includes a storage unit 110, a job management unit 120, a power consumption acquisition unit 130, and a power coefficient update unit 140. The storage unit 110 is, for example, implemented as a storage area secured for the RAM 102 or the NVRAM 103. The job management unit 120, the power consumption acquisition unit 130, and the power coefficient update unit 140 are implemented when the processor 101 executes a program stored in the RAM 102.

The storage unit 110 holds a power coefficient table. The power coefficient table is information in which power coefficients corresponding to the compute nodes 200, 200a, 200b, and 200c, respectively, are registered.

The job management unit 120 acquires job information from the login node 300. In the job information, information indicating a job including a plurality of programs to be executed in parallel is included. In addition, the job management unit 120 schedules a timing at which a job is submitted. Furthermore, at the time of submitting a job, the job management unit 120 deploys a program indicating the details of the job on the compute nodes 200, 200a, 200b, and 200c. The job management unit 120 sends a startup command for executing the deployed program to the compute nodes 200, 200a, 200b, and 200c. Thus, the job is executed in parallel by the compute nodes 200, 200a, 200b, and 200c.

In scheduling of jobs, the job management unit 120 takes into account the power consumption of each compute node associated with execution of each job. The job management unit 120 uses the power coefficient of each compute node stored in the storage unit 110 to predict a power consumption associated with execution of a job. For example, with such a power coefficient, the job management unit 120 may estimate the power consumption of each compute node associated with execution of a job by using formula (1).

Here, as described above, when some compute node fails and is replaced with a new compute node, the management node 100 recalculates the power coefficient for the compute node after the replacement. The management node 100 includes the power consumption acquisition unit 130 and the power coefficient update unit 140 described below, separately from the job management unit 120, as functionality of determining the power coefficient of a compute node.

After execution of a job is complete, the power consumption acquisition unit 130 acquires the power consumption of each of the compute nodes 200, 200a, 200b, and 200c. For example, the power consumption acquisition unit 130 may continuously acquire a measured value of power consumption while some job is being executed from the compute node 200, and acquire the mean of measured values at the acquisition timings as the power consumption of the compute node 200 associated with execution of the job. Alternatively, if the compute node 200 has functionality of acquiring a measured value of power consumption associated with execution of a job, the power consumption acquisition unit 130 may acquire a measured value of power consumption calculated by the compute node 200 from the compute node 200 after execution of the job is complete. In such a way, the power consumption acquisition unit 130 is able to acquire the power consumption of each compute node associated with execution of a job. In addition, the power consumption acquisition unit 130 acquires the total number of instructions executed by a compute node after replacement in association with execution of a job.

The power coefficient update unit 140 updates a power coefficient. Here, in the case of updating a power coefficient, it is desired to determine whether or not an executed job is divided into tasks with an equal total number of instructions for all of the compute nodes and to update the power coefficient of a compute node by using a job divided into tasks with an equal total number of instructions.

Accordingly, the power coefficient update unit 140 detects a job of single program, multiple data streams (SPMD) among a plurality of jobs to be executed and uses the job to update a power coefficient. SPMD is a method of causing a plurality of compute nodes to execute the same program in parallel, and has a property in which, with any SPMD job, an approximately equal number of instructions are assigned to each compute node. Therefore, the power coefficient update unit 140 evaluates variation in power consumption of each compute node by execution of the job in question based on the power consumption acquired from the compute node by the power consumption acquisition unit 130. Note that, in general, variation in power coefficient among compute nodes with the same design specifications is sufficiently smaller than variation in the total number of instructions among compute nodes when the job is not an SPMD job, and is sufficiently larger than variation in the total number of instructions among compute nodes when the job is an SPMD job.

The power coefficient update unit 140 uses an SPMD evaluation threshold Ts (in units of W) for evaluating the variation in question. The reason of this is to determine whether or not an approximately equal number of instructions are assigned to each compute node owing to execution of the target job. For example, if the difference between the largest power consumption and the smallest power consumption among the power consumptions of compute nodes is smaller than the SPMD evaluation threshold, the power coefficient update unit 140 is able to evaluate that the job in question is an SPMD job and that an approximately equal number of instructions are assigned to each compute node. In contrast, if the difference between the largest power consumption and the smallest power consumption is larger than or equal to the SPMD evaluation threshold, the power coefficient update unit 140 is able to evaluate that the job in question is not an SPMD job and is not a job with which an approximately equal number of instructions are assigned to each compute node. Note that, when obtaining the largest power consumption and the smallest power consumption, the power coefficient update unit 140 may remove the power consumption of a compute node after replacement. This is because there is a possibility that an initial defect exists in the compute node after replacement, and there is a danger that the determination accuracy could deteriorate when a job is evaluated by using the power consumption of the compute node with an initial defect.

Using a power consumption associated with execution of a job detected in such a way, the power coefficient update unit 140 updates the power coefficient of a compute node after replacement by using formula (1). The power coefficient update unit 140 records the updated power coefficient in association with the compute node after replacement in the storage unit 110.

Next, a power coefficient table stored in the storage unit 110 will be described in detail.

FIG. 7 is a diagram depicting an example of a power coefficient table of the second embodiment. A power coefficient table 111 is stored in the storage unit 110. The power coefficient table 111 includes items of compute node IDs and the power coefficients. Information that identifies a compute node is registered in the item of compute node IDs. Information representing a power coefficient is registered in the item of power coefficients.

Here, for example, the compute node ID of the compute node 200 is “N1”. The compute node ID of the compute node 200a is “N2”. The compute node ID of the compute node 200b is “N3”. The compute node ID of the compute node 200c is “N4”.

For example, information with a compute node ID “N1” and a power coefficient “r1” is registered in the power coefficient table 111. This information represents that the power coefficient of the compute node 200 is “r1”. Likewise, for the compute nodes 200a, 200b, and 200c, the power coefficients are registered in the power coefficient table 111.

Next, a process of calculating and updating power coefficients in usual operation in the computing system will be described in detail. In a procedure described below, the case where some compute node fails, and the failed compute node is replaced with a new replacement node is assumed. The compute node after the replacement is assumed as the compute node 200b.

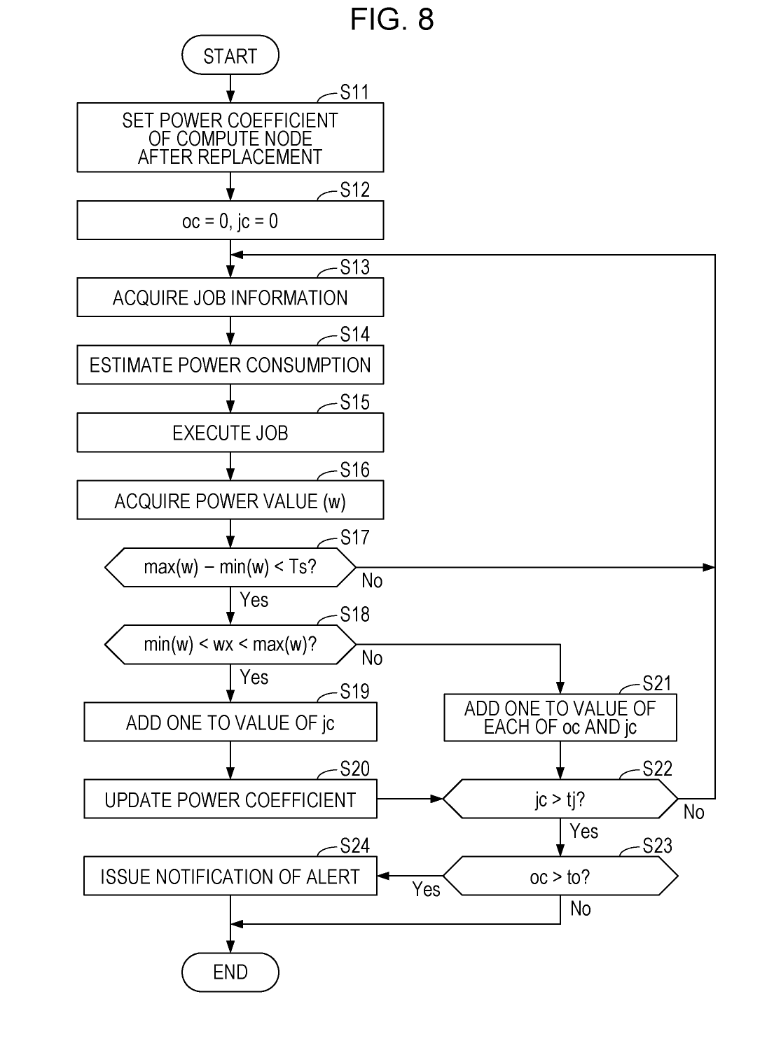

FIG. 8 is a flowchart illustrating an example of determination of a power coefficient of the second embodiment. The process illustrated in FIG. 8 will be described below along step numbers.

(S11) The job management unit 120 sets the power coefficient of the compute node 200b, which is a compute node after replacement, in the power coefficient table 111. In particular, the job management unit 120 refers to the power coefficient table 111 and registers the mean of power coefficients r1, r2, and r4 of the compute nodes 200, 200a, and 200c as the power coefficient of the compute node 200b in the power coefficient table 111.

(S12) The power coefficient update unit 140 substitutes zero in an over counter oc. The over counter oc is a counter for determining whether or not there is an initial defect in the compute node 200b after replacement. The over counter oc counts the number of jobs for which the measured power consumption of the compute node 200b after replacement is not within a given range. In addition, the power coefficient update unit 140 substitutes zero in a job execution number counter jc. The job execution number counter jc is a counter that counts the number of times a job is executed.

(S13) The job management unit 120 acquires job information from the login node 300. The job management unit 120 stores job information in the storage unit 110.

(S14) The job management unit 120 substitutes the power coefficient of each compute node registered in the power coefficient table 111 and the total number of instructions corresponding to a job scheduled to be executed, the total number of instructions being stored in the storage unit 110, in formula (1) to estimate power consumption of the compute node. Further, the job management unit 120 schedules timings at which the job is executed. Here, considering the estimated power consumptions, the job management unit 120 schedules timings at which the job is executed so that the power consumption of the entire computing system does not become excessively large.

(S15) The job management unit 120 executes the job in parallel with the compute nodes 200, 200a, 200b, and 200c at timings in accordance with the result of scheduling.

(S16) The power consumption acquisition unit 130 acquires a power consumption w associated with execution of the job from each of the compute nodes 200, 200a, 200b, and 200c. Here, the power consumption of the compute node 200 is denoted by w1, the power consumption of the compute node 200a is denoted by w2, the power consumption of the compute node 200b is denoted by w3, and the power consumption of the compute node 200c is denoted by w4. For example, as described above, the job management unit 120 may periodically acquire the power consumption measured during execution of a job in question from each of the compute nodes 200, 200a, 200b, and 200c and determine the mean of the power consumptions at all acquisition timings as a power consumption associated with execution of this job. Alternatively, after accepting a notification of completion of execution of a job from each of the compute nodes 200, 200a, 200b, and 200c, the power consumption acquisition unit 130 may acquire a power consumption obtained by each compute node. In addition, the power consumption acquisition unit 130 acquires from the compute node 200b a total number of instructions c3 executed by the compute node 200b in association with execution of the job.

(S17) The power coefficient update unit 140 identifies the largest power consumption max (w) and the smallest power consumption min (w) from among the power consumption w1, the power consumption w2, and the power consumption w4 acquired from the compute nodes 200, 200a, and 200c. The reason why the power consumption w3 of the compute node 200b is excluded is that the exclusion increases the accuracy in the detection of a job of SPMD as described above. The power coefficient update unit 140 determines whether or not the difference between the largest and smallest values of power consumption (max (w)−min (w)) is smaller than an SPMD evaluation threshold Ts. If max (w)−min (w)<Ts, the total numbers of instructions executed by the compute nodes 200, 200a, and 200c are highly likely to be approximately the same, and thus the process proceeds to step S18. If max (w)−min (w)≧Ts, there is a relatively large difference among the total numbers of instructions executed by the compute nodes 100, 200a and 200c, and thus the process proceeds to step S13. Note that the threshold Ts is registered in advance (for example, Ts=about 10 W, or the like) in the storage unit 110 by the user. Alternatively, the power coefficient update unit 140 may dynamically set the threshold Ts, such as setting the threshold Ts to about 10% of the mean of collected power consumptions.

(S18) The power coefficient update unit 140 determines whether or not a power consumption (wx) acquired from a compute node after replacement has a value between the largest value and the smallest value of power consumption identified in step S17. Here, since wx=w3, the power coefficient update unit 140 determines whether min (w)<w3<max (w). If min (w)<w3<max (w) holds, the process proceeds to step S19. If min (w)<w3<max (w) does not hold, the process proceeds to step S21. Note that, if min (w)<w3<max (w) does not hold, it is proved that the power consumption of the compute node 200b deviates from the power consumptions of the other compute nodes. This suggests a possibility that there is an initial defect in the compute node 200b.

(S19) The power coefficient update unit 140 adds one to the value of the job execution number counter jc.

(S20) The power coefficient update unit 140 updates the power coefficient of the compute node 200b. In particular, it is assumed that the power coefficient of the compute node 200b registered in the power coefficient table 111 is r31 (the previous power coefficient). The power coefficient update unit 140 calculates a power coefficient r32=(w3/c3) in accordance with the current execution of the job, based on formula (1). Further, the power coefficient update unit 140 sets the current update result r3 of the power coefficient such that r3=(r31+r32)/2. The power coefficient update unit 140 registers the calculated power coefficient r3 in the power coefficient table 111 to update the power coefficient of the compute node 200b. Then, the process proceeds to step S22.

(S21) The power coefficient update unit 140 adds one to the value of the over counter oc. The power coefficient update unit 140 adds one to the value of the job execution number counter jc.

(S22) The power coefficient update unit 140 determines whether or not the value of the job execution number counter jc is greater than a job execution number counter threshold tj (jc>tj). If jc>tj, the process proceeds to step S23. If jc≦tj, the process proceeds to step S13. Here, the job execution number counter threshold tj is registered in advance in the storage unit 110 by the user.

(S23) The power coefficient update unit 140 determines whether or not the value of the over counter oc is greater than an over counter threshold to (oc>to). If oc>to, the process proceeds to step S24. If oc≦to, the process is completed. Here, the over counter threshold to is registered in advance in the storage unit 110 by the user.

(S24) The power coefficient update unit 140 notifies the login node 300 of an alert to the effect that a power consumption deviated compared to the power consumptions of other compute nodes is measured for the compute node 200b, which is the compute node after replacement, and there is a possibility that there is an initial defect in the compute node 200b. For example, the login node 3 proposes this alert to the user to prompt the user to maintain the compute node 200b. Then, the process is completed.

In this way, the management node 100 repeatedly executes the process in step S13 to step S22 until the job execution number counter (jc) reaches a threshold (tj), updating the power coefficient of the compute node 200b. Thus, the accuracy in determining a power coefficient for the compute node 200b may be increased.

In addition, as described above, the management node 100 may detect the possibility of a defect in the compute node 200b after replacement by using the over counter oc and issue an alert. This enables the user to be prompted to perform early maintenance to support stable operation of the computing system.

In this way, according to the second embodiment, the management node 100 selects a job suitable for determining a power coefficient from among jobs to be executed in usual operation of the computing system, and updates the power coefficient of each node based on power consumption associated with execution of the selected job. Therefore, in the computing system of the second embodiment, only for determining a power coefficient, time may not be used to execute a test program. Usual operation of the computing system may also not be interrupted. In addition, a test program may not be executed. This results in avoiding consuming extra power in the computing system only for obtaining a power coefficient. In addition, a power coefficient is updated by the power coefficient update unit 140 separately from the job management unit 120, and thus there is an advantage in that it is possible to determine a power coefficient while reducing influences on the job management unit 120 used for usual operation.

In this way, with the computing system of the second embodiment, the power coefficient of a compute node may be obtained efficiently in usual operation without execution of a special program for testing. In addition, by using a power coefficient obtained in such a way, the management node 100 may appropriately schedule job execution based on power consumptions. For example, prior to executing a certain job, the management node 100 obtains the predicted power consumption of each compute node by using formula (1) with the power coefficient of each compute node registered in the power coefficient table 111. Further, the management node 100 may predict the power consumption of the entirety of compute nodes from the sum of the respective predicted power consumptions of compute nodes, and may appropriately schedule job execution in accordance with the predicted power consumption.

### Third Embodiment

Next, a third embodiment will be described. Items that differ from those of the second embodiment described above will be mainly described, and description of items in common with those of the second embodiment is omitted.

Here, in some computing systems, execution of a regular job, such as weather prediction, is the main application. In such a computing system, an irregular job, which is executed singly, is executed in some cases. Accordingly, in the third embodiment, in such a computing system, functionality of identifying a job that is regularly executed and obtaining a power coefficient of each compute node based on the power consumption associated with execution of the job is provided. When there is a job that is regularly executed, obtaining a power consumption by using this job results in obtaining a power coefficient suitable for actual operation.

Note that, in the third embodiment, the same computing system as in the second embodiment is assumed. Therefore, in the third embodiment, each element is denoted by the same reference numeral or name as in the second embodiment.

Hereinafter, the procedure of determining a power coefficient in the third embodiment will be described. In the procedure described below, the case where a certain compute node fails, and the failed compute node is replaced with a new compute node is assumed. The compute node after replacement is denoted as the compute node 200c. Note that, after replacement of the compute node, the management node 100 deletes the power coefficient for the compute node in question from the power coefficient table 111 (in this example, as a result, no power coefficient is set for the compute node 200c).

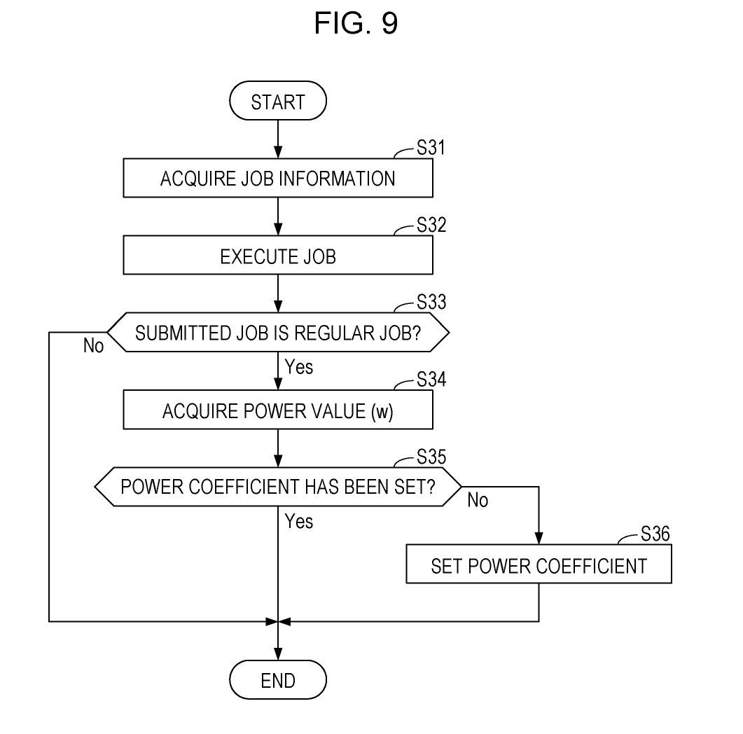

FIG. 9 is a flowchart illustrating an example of determination of a power coefficient in the third embodiment. Hereinafter, the process illustrated in FIG. 9 will be described along step numbers.

(S31) The job management unit 120 acquires job information from the login node 300. The job management unit 120 stores the job information in the storage unit 110.

(S32) The job management unit 120 performs scheduling of a job, and executes the job in parallel with the compute nodes 200, 200a, 200b, and 200c at timings in accordance with the scheduling result. At this point, in order to perform scheduling of a job, the job management unit 120 predicts the power consumption of the compute node 200c in association with execution of the job in question assuming that the power coefficient of the compute node 200c is the mean of power coefficients of the compute nodes 200, 200a, and 200b.

(S33) The power consumption acquisition unit 130 determines whether or not the executed job is a regular job that is executed regularly. For example, the power consumption acquisition unit 130 determines whether or not the job in question is a regular job, based on the job name of the job in question, the user name of a user who regularly provides an instruction for execution of a job, or the like. If the job in question is a regular job, the process proceeds to step S34. If the job in question is not a regular job, the process is completed.

(S34) The power consumption acquisition unit 130 acquires power consumptions (w) associated with execution of the regular job from the compute nodes 200, 200a, 200b, and 200c. A specific example of the acquisition method is similar to that in step S16. In addition, the power consumption acquisition unit 130 acquires the total numbers of instructions executed in accordance with the job in question from the compute nodes, 200, 200a, 200b, and 200c.

(S35) The power coefficient update unit 140 refers to the power coefficient table 111 and determines whether or not the respective power coefficients of the compute nodes 200, 200a, 200b, and 200c have already been set. If the power coefficients have not been set, the process proceeds to step S36. If the power coefficients have been set, the process is completed.

(S36) The power coefficient update unit 140 sets the power coefficient of the compute node 200c. In particular, the power coefficient update unit 140 calculates (the power consumption of the compute node 200c acquired in step S34)÷(the total number of instructions of the compute node 200c acquired in step S34) based on formula (1) to obtain the power coefficient r4 of the compute node 200c. The power coefficient update unit 140 registers the calculated power coefficient in the power coefficient table 111. Then, the process is completed.

In this way, for example, in usual operation of the computing system, if there is a regular job, the power consumption associated with execution of the regular job may be acquired from each compute node and be used for determining a power coefficient.

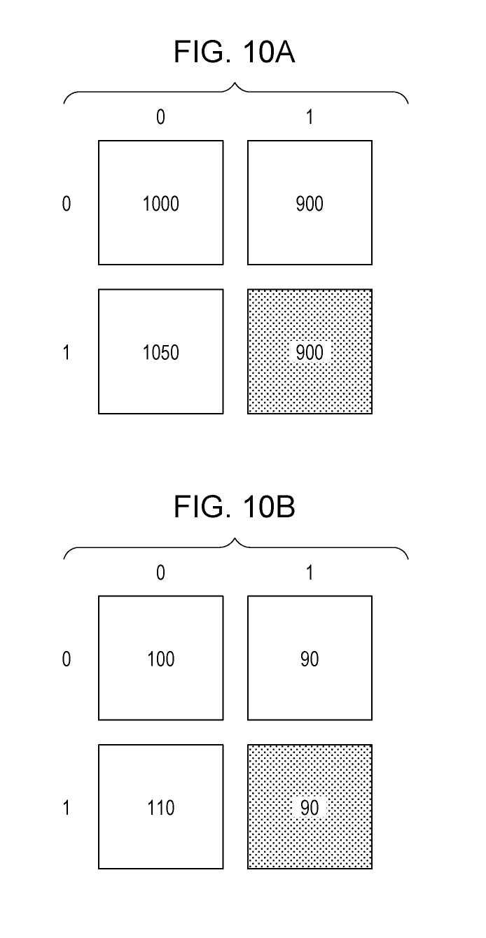

FIG. 10A and FIG. 10B are diagrams illustrating an example of the total numbers of instructions and an example of predicted power consumptions in the third embodiment. In the description given below, a job that operates with 2×2, four nodes (that is, the compute nodes 200, 200a. 200b, and 200c) is assumed. In FIG. 10, one rectangle corresponding to a pair of a row number and a column number corresponds to one compute node (similarly in the drawings referred to below). For example, (row, column)=(0, 0) denotes the compute node 200. In addition, (row, column)=(0, 1) denotes the compute node 200a, (row, column)=(1, 0) denotes the compute node 200b, and (row, column)=(1, 1) denotes the compute node 200c. As in the example described above, the case where the compute node 200c is a node after replacement is assumed (the rectangle corresponding to the compute node 200c is illustrated in a hutched manner).

FIG. 10A illustrates an example of the total number of instructions executed by each compute node for a certain regular job. In particular, the total number of instructions of the compute node 200 is “1000”. The total number of instructions of the compute node 200a is “900”. The total number of instructions of the compute node 200b is “1050”. The total number of instructions of the compute node 200c is “900”.

FIG. 10B illustrates an example of power consumptions predicted during execution of a certain regular job. In particular, the predicted power consumption of the compute node 200 is “100” W. The predicted power consumption of the compute node 200a is “90” W. The predicted power consumption of the compute node 200b is “110” W. The predicted power consumption of the compute node 200c is “90” W.

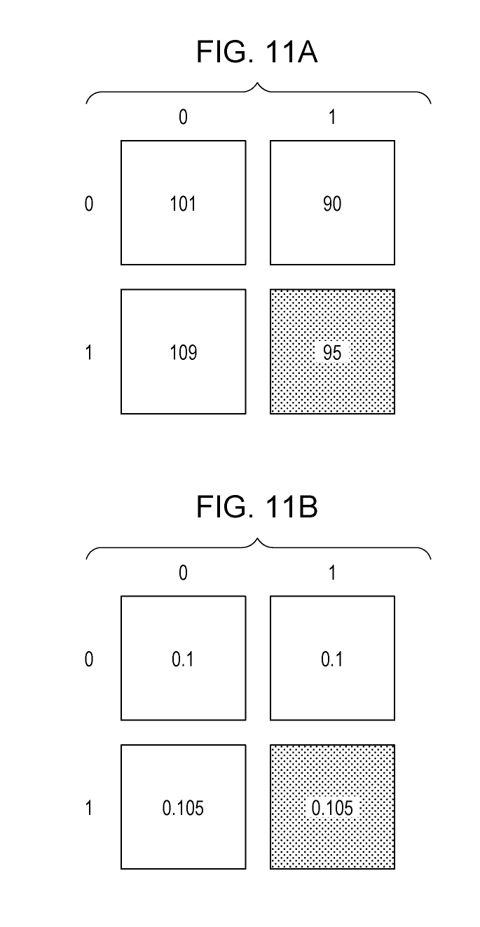

FIG. 11A and FIG. 11B illustrate an example of measured power consumptions and an example of power coefficients in the third embodiment. FIG. 11A illustrates an example of power consumptions actually measured (actually measured power consumptions) for execution of a certain regular job. In particular, the measured power consumption of the compute node 200 is “101” W. The measured power consumption of the compute node 200a is “90” W. The measured power consumption of the compute node 200b is “109” W. The measured power consumption of the compute node 200c is “95” W.

FIG. 11B illustrates an example of power coefficients of the compute nodes 200, 200a, 200b, and 200c after execution of a certain regular job. In particular, the power coefficient of the compute node 200 is “0.1”. The power coefficient of the compute node 200a is “0.1”. The power coefficient of the compute node 200b is “0.105”. The power coefficient of the compute node 200c is “0.105”. Among these coefficients, the power coefficient r4 of the compute node 200c is a value calculated based on the total number of instructions “900” of the compute node 200c in FIG. 10A and the measured power consumption “95” W of the compute node 200c in FIG. 11A. That is, r4=95÷900=0.105 (discard all numbers after the third decimal place).

In this way, in the third embodiment, like in the second embodiment, a job to be executed in usual operation is selected, and the power coefficient of each compute node is updated based on power consumptions associated with execution of the job. Therefore, also in the computing system of the third embodiment, only for determining a power coefficient, time may not be used to execute a test program. Usual operation of the computing system may not be interrupted. In addition, since a test program may not be executed, extra power only for obtaining a power coefficient may not be consumed in the computing system.

Thus, with the computing system of the third embodiment, as in the second embodiment, the power coefficient of a compute node may be efficiently obtained in usual operation. Note that, the information processing of the first embodiment may be implemented by causing the operation unit 11b to execute a program. The information processing of the second and third embodiments may be implemented by causing the processor 101 to executed a program. Programs are capable of being recorded on a computer-readable recording medium.

For example, distributing the recoding medium 43 on which a program is recorded enables the program to be circulated. In addition, a program is stored in another computer (for example, the data storage server 400), and may be distributed over a network. A computer may, for example, store (install) a program recorded on the recording medium 43 or a program received from another computer in a storage device, such as RAM or NVRAM, and read the program from the storage device and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A parallel processing apparatus comprising:
a plurality of calculation nodes that execute a job in parallel, and
a management node that manages operations of the plurality of calculation nodes,
wherein each of the plurality of calculation nodes including a first memory and a first processor coupled to the first memory and configured to execute a respective part of the job, and
wherein the management node including;
a second memory configured to store, for each of the plurality of calculation nodes, a power coefficient that is used to calculate a power consumption of the calculation node in accordance with execution of the job; and
a second processor coupled to the second memory and configured to execute a process including;
when executing the job in parallel by using the plurality of calculation nodes, identifying an execution of a first job, among a plurality of jobs to be executed, having a difference in power consumptions of the calculation nodes smaller than a predetermined value,
measuring, during the execution of the first job, a power consumption of at least one of the calculation nodes,
calculating, based on the measured power consumption, the power coefficient of the at least one of the calculation nodes, and
updating the stored power coefficient in the second memory based on the calculated power coefficient.

2. The parallel processing apparatus according to claim 1, wherein the identifying includes;
detecting a largest value and a smallest value from among power consumptions of the plurality of calculation nodes, and
setting a job, during an execution of which a difference between the largest value and the smallest value is smaller than the predetermined value, as the first job.

3. The parallel processing apparatus according to claim 1, wherein in the updating, the stored power coefficient is updated based on a previously updated power coefficient and a currently calculated power coefficient, each time the execution of the first job is detected.

4. The parallel processing apparatus according to claim 1, wherein, when a calculation node after replacement is included in the plurality of calculation nodes, the power coefficient for the replaced calculation node stored in the second memory is updated based on the calculated power coefficient based on the measured power consumption during the execution of the first job.

5. The parallel processing apparatus according to claim 4, wherein the process further including;
detecting a defect of the replaced calculation node in accordance with a counted number of jobs for which a power consumption of the replaced calculation node is not included in a range between a largest value and a smallest value of power consumptions of the calculation nodes other than the replaced calculation node.

6. The parallel processing apparatus according to claim 1, wherein in the identifying, a job to be regularly executed is identified as the first job.

7. A non-transitory computer-readable recording medium having stored therein a power coefficient calculation program that, when executed by a computer, causes the computer to execute a process, the process comprising
when executing a job in parallel by using a plurality of calculation nodes, measuring power consumptions of the respective calculation nodes, during execution of a first job having a difference in power consumption of the node smaller than a given value among a plurality of jobs to be executed,
calculating power coefficients of respective calculation nodes, based on a power consumption measured, the power coefficients being used to calculate power consumption of the respective calculation nodes in accordance with execution of the job, and
updating the respective power coefficients, stored in a memory, based on the calculated power coefficients.

8. A power coefficient calculation method executed by a computer, comprising;
when executing a job in parallel by using a plurality of calculation nodes, calculating and updating a power coefficient of each of the plurality of calculation nodes, the power coefficient being used to calculate a power consumption of the calculation node in accordance with execution of the job, based on a power consumption measured during an execution of a first job having a difference in power consumptions of the calculation nodes smaller than a given value among a plurality of jobs to be executed.
